(19) United States
(12) Patent Application Publication
(10) Pub. No.: US 2025/0218641 A1
(43) Pub. Date: Jul. 3, 2025

(54) LAMINATED COIL COMPONENT AND METHOD OF MANUFACTURING SAME

(71) Applicant: Murata Manufacturing Co., Ltd., Kyoto-fu (JP)

(72) Inventors: Maasa NAKANO, Nagaokakyo-shi (JP); Reiji OZAWA, Nagaokakyo-shi (JP)

(73) Assignee: Murata Manufacturing Co., Ltd., Kyoto-fu (JP)

(21) Appl. No.: 19/003,341

(22) Filed: Dec. 27, 2024

(30) Foreign Application Priority Data
Dec. 28, 2023 (JP) 2023-222748

(51) Int. Cl. H01F 17/00; H01F 5/04; H01F 5/06; H01F 41/04

(52) U.S. Cl. CPC H01F 17/0013; H01F 5/04; H01F 5/06; H01F 41/043

(57) ABSTRACT

A laminated coil component includes a multilayer body including laminated insulation layers and a coil inside; and first and second outer electrodes electrically connected to the coil. The coil is composed of coil conductors laminated together with the insulation layers and electrically connected to one another. The multilayer body has first and second end surfaces opposed to each other in a longitudinal direction, first and second main surfaces opposed to each other in a height direction orthogonal to the longitudinal direction, and first and second side surfaces opposed to each other in a width direction orthogonal to the longitudinal direction and the height direction. A coil axis of the coil is parallel to the first main surface. The multilayer body further includes a plate-shaped member laminated together with the insulation layers.

### CROSS-REFERENCE TO RELATED APPLICATION

This application claims benefit of priority to Japanese Patent Application No. 2023-222748, filed Dec. 28, 2023, the entire content of which is incorporated herein by reference.

### BACKGROUND

### Technical Field

The present disclosure relates to a laminated coil component and a method of manufacturing a laminated coil component.

### Background Art

Japanese Unexamined Patent Application Publication No. 2001-196240 discloses a method of manufacturing a laminated coil component by laminating a plurality of ceramic green sheets on surfaces of which a conductor pattern serving as a coil conductor is printed to produce an element including a coil inside, and forming outer electrodes on both end surfaces of the element in the lamination direction.

### SUMMARY

However, when the outer electrodes are formed on multilayer bodies manufactured by the method described in Japanese Unexamined Patent Application Publication No. 2001-196240, defects in forming the outer electrodes can occur under a specific condition.

In the case in which laminated coil components are manufactured by the method described in Japanese Unexamined Patent Application Publication No. 2001-196240, in the end surfaces of elements in the lamination direction, the portion overlapping circling-shape portions of the coil bulges, and the portion on the inner side of the circling-shape portions of the coil can be relatively depressed in some cases. The portion that occurs in such cases, caused by the portion overlapping the circling-shape portions of the coil and bulging over the surroundings is referred to as a “coil mark”.

It is conceivable that if a “coil mark” occurs in an end surface of an element on which an outer electrode is to be formed, when a paste serving as an outer electrode is applied to the end surface of the element, a bubble is trapped in the depression at the center of the coil mark, leading to a defect in forming the outer electrode.

However, the fact that coil marks cause defects in forming outer electrodes has not been known with conventional laminated coil components.

Coil marks occur in the end surfaces of an element in the lamination direction. However, in Japanese Unexamined Patent Application Publication No. 2001-196240, outer electrodes are formed on end surfaces of an element different from the end surfaces in the lamination direction. Hence, if the end surfaces in which coil marks occur differ from the end surfaces on which the outer electrodes are formed, defects in forming outer electrodes do not occur.

Depending on the size (depth) of coil marks, coil marks do not cause defects in forming outer electrode. The size of coil marks in conventional laminated coil components is small. Hence, even if a paste serving as an outer electrode is applied to an end surface of an element, a bubble is not trapped in a depression at the center of the coil mark.

However, in the case in which the size of an element is increased or the number of laminated coil conductor layers is increased to improve the performance of a laminated coil component, the depth of the coil mark increases (becomes deeper). In such cases, it was found that when a paste serving as an outer electrode is applied, a bubble is trapped in a depression at the center of the coil mark, which can cause defects in forming outer electrodes.

As described above, defects in forming outer electrode due to coil marks are problems caused conspicuously by a combination of conditions in which the depth of coil marks increases, such as when the size of laminated coil components is large and when the number of laminated coil conductor layers is large, and a condition that the end surfaces in which coil marks occur are the same as the end surfaces on which outer electrodes are formed. Hence, this has not been widely recognized.

Accordingly, the present disclosure provides a laminated coil component in which coil marks in the end surfaces of the element body are small, and structural defects in the outer electrodes are less likely.

A laminated coil component of the present disclosure includes a multilayer body including a plurality of laminated insulation layers and including a coil inside; and first and second outer electrodes electrically connected to the coil. The coil is composed of a plurality of coil conductors laminated together with the insulation layers and electrically connected to one another. The multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction. A coil axis of the coil is parallel to the first main surface. The multilayer body further includes a plate-shaped member laminated together with the insulation layers. A dimension of the plate-shaped member in a direction perpendicular to the coil axis being larger than a dimension of the plate-shaped member in a direction parallel to the coil axis, and an area of the plate-shaped member is smaller than an area of the first end surface of the multilayer body.

With the present disclosure, it is possible to provide a laminated coil component in which coil marks in the end surfaces of the element body are small, and structural defects in the outer electrodes are less likely.

### BRIEF DESCRIPTION OF THE DRAWINGS

FIG. 1 is a schematic perspective view of an example of a laminated coil component of the present disclosure;

FIG. 2 is a schematic exploded perspective view of an example of a multilayer body included in the laminated coil component in illustrated in FIG. 1;

FIG. 3 is a transparent side view of the multilayer body included in the laminated coil component illustrated in FIG. 1, schematically illustrating an example of the internal structure;

FIG. 4 is a cross-sectional view of the laminated coil component illustrated in FIG. 1, schematically illustrating an example of the cross section taken along line segment A1-A1;

FIG. 5 is a schematic cross-sectional view of an example of a laminated coil component without plate-shaped members;

FIG. 6 is a side view of the laminated coil component illustrated in FIG. 5, from the first end surface side;

FIG. 7 is a schematic exploded view of another example of a multilayer body included in a laminated coil component of the present disclosure;

FIG. 8 is a transparent side view of the multilayer body illustrated in FIG. 7, schematically illustrating an example of the internal structure;

FIG. 9 is a schematic exploded view of another example of a multilayer body included in a laminated coil component of the present disclosure;

FIG. 10 is a schematic exploded view of still another example of a multilayer body included in a laminated coil component of the present disclosure;

FIG. 11 is a schematic exploded view of still another example of a multilayer body included in a laminated coil component of the present disclosure;

FIG. 12 is a schematic exploded view of still another example of a multilayer body included in a laminated coil component of the present disclosure;

FIG. 13 is a schematic exploded view of still another example of a multilayer body included in a laminated coil component of the present disclosure; and

FIG. 14 shows a graph obtained by plotting the relationship between the ratio of the area of a plate-shaped member to the cross-sectional area of a coil and the depth of a depression for each of the laminated coil components according to Implementation Examples 1 to 6, and an approximation curved line added to the graph.

### DETAILED DESCRIPTION

Hereinafter, a laminated coil component of the present disclosure will be described. The present disclosure is not limited to the following configurations, which may be changed as appropriate within a range not departing from the spirit of the present disclosure.

Combinations of two or more individual preferred configurations described in the following are also included in the present disclosure.

The drawings described in the following are schematic, and hence, the dimensions, the scale of the ratio of longitudinal dimensions and lateral dimensions, and the like sometimes differ from those of the actual product. In the figures, the same or corresponding portions are denoted by the same symbols. In the figures, the same elements are denoted by the same symbols, and repetitive description thereof is omitted.

In the present specification, the terms indicating the relationships of components (for example, “parallel”, “orthogonal”, and the like) and the terms indicating the shapes of components not only denote literal configurations in a strict sense but also include substantially equivalent ranges, for example, ranges including differences of about several percent.

Each embodiment in the following is to show an example, and hence it goes without saying that constituents shown in different embodiments can be partially replaced or combined with one another. In a second embodiment and after, description of the items common to those of a first embodiment will be omitted, and only different points will be described. In particular, the same or similar operational advantages by the same or similar configurations will not be referred to in each embodiment.

### Laminated Coil Component

A laminated coil component of the present disclosure includes: a multilayer body including a plurality of laminated insulation layers and including a coil inside; and first and second outer electrodes electrically connected to the coil. The coil is composed of a plurality of coil conductors laminated together with the insulation layers and electrically connected to one another. The multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction. A coil axis of the coil is parallel to the first main surface. The multilayer body further includes a plate-shaped member laminated together with the insulation layers. A dimension of the plate-shaped member in a direction perpendicular to the coil axis is larger than a dimension of the plate-shaped member in a direction parallel to the coil axis, and the area of the plate-shaped member is smaller than the area of the first end surface of the multilayer body.

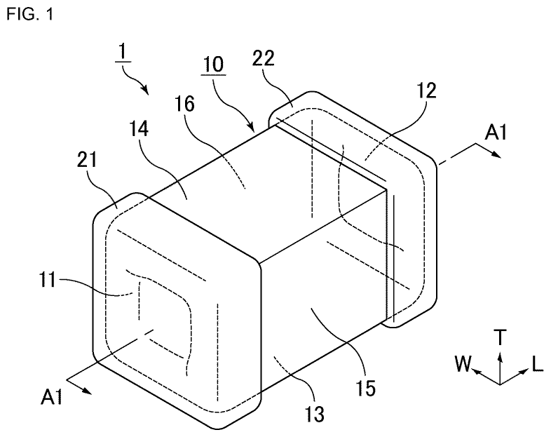

FIG. 1 is a schematic perspective view of an example of a laminated coil component of the present disclosure. The laminated coil component 1 illustrated in FIG. 1 includes a multilayer body (element body) 10 and first and second outer electrodes 21 and 22 provided on outer surfaces of the multilayer body 10. The multilayer body 10 has a rectangular parallelepiped shape having six surfaces. Although the configuration of the multilayer body 10 will be described later, the multilayer body 10 includes a plurality of insulation layers and a plurality of coil conductors laminated in the lamination direction and thus includes a coil inside. Each of the first outer electrode 21 and the second outer electrode 22 is electrically connected to the coil.

In the laminated coil component and the multilayer body in the present specification, the longitudinal direction, the height direction, and the width direction are defined as the L direction, the T direction, and the W direction in FIG. 1. The longitudinal direction L, the height direction T, and the width direction W are orthogonal to one another. The longitudinal direction Lis parallel to the lamination direction.

As illustrated in FIG. 1, the multilayer body 10 has a first end surface 11 and a second end surface 12 opposed to each other in the longitudinal direction L, a first main surface 13 and a second main surface 14 opposed to each other in the height direction T orthogonal to the longitudinal direction L, and a first side surface 15 and a second side surface 16 opposed to each other in the width direction W orthogonal to the longitudinal direction L and the height direction T.

Although not illustrated in FIG. 1, it is preferable that the corners and the ridge lines of the multilayer body 10 be rounded. A corner is a portion at which three surfaces of the multilayer body intersect one another, and a ridge line is a portion on which two surfaces of the multilayer body intersect each other.

For example, as illustrated in FIG. 1, the first outer electrode 21 covers all of the first end surface 11 of the multilayer body 10 and extends from the first end surface 11 to cover part of the first main surface 13, part of the second main surface 14, part of the first side surface 15, and part of the second side surface 16.

For example, as illustrated in FIG. 1, the second outer electrode 22 covers all of the second end surface 12 of the multilayer body 10 and extends from the second end surface 12 to cover part of the first main surface 13, part of the second main surface 14, part of the first side surface 15, and part of the second side surface 16.

Thus, when the laminated coil component 1 having the first outer electrode 21 and the second outer electrode 22 is mounted on a board, one of the first main surface 13, the second main surface 14, the first side surface 15, and the second side surface 16 of the multilayer body 10 serves as the mounting surface.

Hence, the first outer electrode 21 needs only to extend over at least part of the first end surface 11 of the multilayer body 10 and the mounting surface of the multilayer body 10.

Similarly, the second outer electrode 22 needs only to extend over at least part of the second end surface 12 of the multilayer body 10 and the mounting surface of the multilayer body 10.

Each of the first outer electrode 21 and the second outer electrode 22 may have a single-layer structure or a multi-layer structure.

In the case in which each of the first outer electrode 21 and the second outer electrode 22 has a single-layer structure, examples of the constituent material of each outer electrode include Ag, Au, Cu, Pd, Ni, Al, and alloys containing at least one of these metals.

In the case in which each of the first outer electrode 21 and the second outer electrode 22 has a multi-layer structure, each outer electrode may include, for example, an underlying electrode layer containing Ag, a Ni film, and a Sn film in this order from the surface of the multilayer body 10.

Although the size of the laminated coil component of the present disclosure is not particularly limited, it is preferable that the size be larger than or equal to 1608 specified in JIS C 5101-21 (2021) (in which the symbol M indicating that the dimensions are based on metric units is omitted).

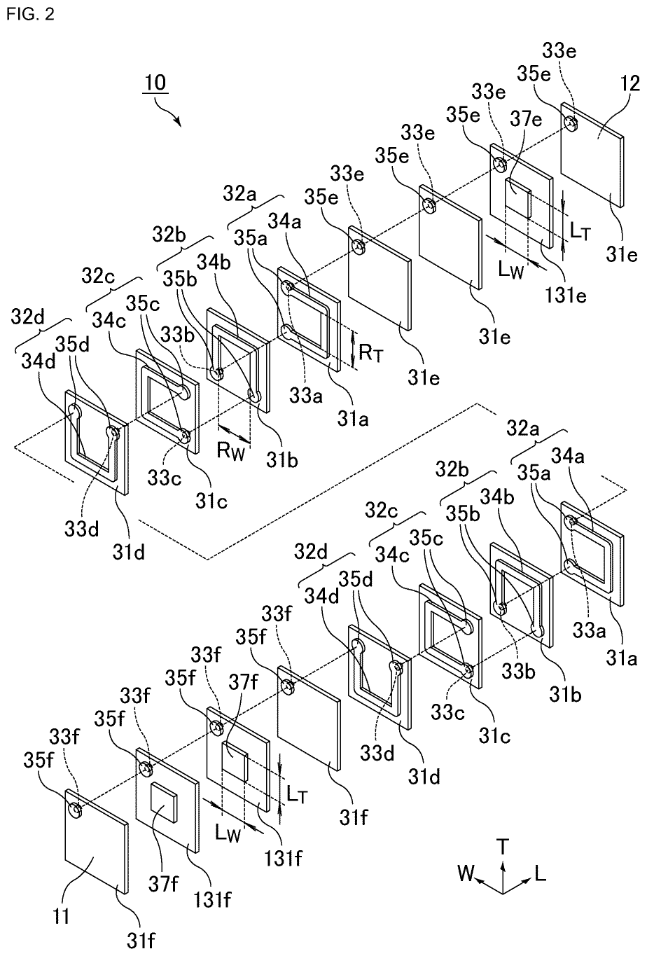

FIG. 2 is a schematic exploded perspective view of an example of the multilayer body included in the laminated coil component illustrated in FIG. 1.

As illustrated in FIG. 2, the multilayer body 10 includes a plurality of insulation layers 31a, 31b, 31c, 31d, 31e, 31f, 131e, and 131f laminated in the lamination direction (in this case, the longitudinal direction L) from the second end surface 12 toward the first end surface 11 of the multilayer body 10. Hereinafter, the insulation layers 31a, 31b, 31c, 31d, 31e, and 31f are also collectively referred to as the insulation layers 31. The insulation layers 131e and 131f are also collectively referred to as the insulation layers 131.

In the present specification, the direction in which the plurality of insulation layers included in the multilayer body are laminated is referred to as the lamination direction.

In FIG. 2, the insulation layers 31e and 131e are located on the lower side in the lamination direction (on the second end surface 12 side of the multilayer body 10), and the insulation layers 31f and 131f are located on the upper side in the lamination direction (on the first end surface 11 side of the multilayer body 10).

Examples of the constituent material of each insulation layer 31 include magnetic materials such as ferrite materials.

The insulation layers 31a, 31b, 31c, and 31d are provided with coil conductors 32a, 32b, 32c, and 32d and via conductors 33a, 33b, 33c, and 33d, respectively. The insulation layer 31e is provided with a via conductor 33e and a pad 35e. The insulation layer 31f is provided with a via conductor 33f and a pad 35f. The insulation layer 131e is provided with a via conductor 33e, a pad 35e, and a plate-shaped member 37e. The insulation layer 131f is provided with a via conductor 33f, a pad 35f, and a plate-shaped member 37f. The total number of insulation layers 131e and 131f may be one or two or more. The total number of insulation layers 31e may be zero, one, or two or more. The total number of insulation layers 31e and 131e may be one or two or more. Similarly, the total number of insulation layers 31f may be zero, one, or two or more. The total number of insulation layers 31f and 131f may be one or two or more. Hereinafter, the coil conductors 32a, 32b, 32c, and 32d are also collectively referred to as the coil conductors 32.

The coil conductors 32a, 32b, 32c, and 32d are provided on main surfaces of the insulation layers 31a, 31b, 31c, and 31d, respectively, and are laminated together with the insulation layers 31a, 31b, 31c, 31d, 31e, 31f, 131e, and 131f. In FIG. 2, each coil conductor 32 has a shape of ¾ turn, and the four insulation layers 31, which are the insulation layers 31a, 31b, 31c, and 31d arranged in this order, are repeatedly laminated as one unit (corresponding to three turns).

The coil conductors 32a, 32b, 32c, and 32d respectively include circling portions 34a, 34b, 34c, and 34d, each having an annular shape in which one portion is missing and a gap is present, and pads 35a, 35b, 35c, and 35d. The pads 35a, 35b, 35c, and 35d are located at both end portions of the circling portions 34a, 34b, 34c, and 34d, respectively. Hereinafter, the circling portions 34a, 34b, 34c, and 34d are also collectively referred to as the circling portions 34.

The via conductors 33a, 33b, 33c, 33d, 33e, and 33f each pass through the corresponding one or ones of the insulation layers 31a, 31b, 31c, 31d, 31e, 31f, 131e, and 131f in the lamination direction. Hereinafter, the via conductors 33a, 33b, 33c, 33d, 33e, and 33f are also collectively referred to as the via conductors 33.

The pads 35e and 35f are provided directly on the via conductors 33e and 33f, respectively. It is preferable that the pads 35a, 35b, 35c, 35d, 35e, and 35f be a little larger than the line widths of the circling portions 34a, 34b, 34c, and 34d. Hereinafter, the pads 35a, 35b, 35c, 35d, 35e, and 35f are also collectively referred to as the pads 35.

Examples of the constituent material of each coil conductor 32, including the circling portion 34 and the pad 35, and each via conductor 33 include Ag, Au, Cu, Pd, Ni, Al, and alloys containing at least one of these metals.

The plurality of insulation layers 31a, 31b, 31c, 31d, 31e, 31f, 131e, and 131f configured as described above are laminated in the lamination direction. This forms the multilayer body 10, and the plurality of coil conductors 32a, 32b, 32c, and 32d are electrically connected to one another with the via conductors 33a, 33b, 33c, and 33d interposed therebetween. Thus, a coil in the form of a solenoid having a coil axis parallel to the lamination direction is formed in the multilayer body 10.

The via conductors 33e and the pads 35e serve as a second extension conductor in the multilayer body 10, part of which is exposed on the second end surface 12 of the multilayer body 10. In other words, the second extension conductor includes the via conductors 33e and the pads 35e. As described later, the second extension conductor connects, in the multilayer body 10, the second outer electrode 22 and the coil conductor 32a facing the second outer electrode 22.

The via conductors 33f and the pads 35f serve as a first extension conductor in the multilayer body 10, part of which is exposed on the first end surface 11 of the multilayer body 10. In other words, the first extension conductor includes the via conductors 33f and the pads 35f. As described later, the first extension conductor connects, in the multilayer body 10, the first outer electrode 21 and the coil conductor 32d facing the first outer electrode 21.

It is preferable that the coil conductors 32 overlap one another when viewed in the lamination direction (the longitudinal direction L). When viewed in the lamination direction, the coil may have a shape composed of straight lines as illustrated in FIG. 2 (for example, a polygonal shape such as a rectangle), may have a shape composed of curved lines (for example, a circular shape), or may have a shape composed of straight lines and curved lines.

The insulation layers 131e and 131f are laminated together with the insulation layers 31a, 31b, 31c, 31d, 31e, and 31f, and thus the multilayer body 10 includes the plate-shaped members 37e and 37f. Hereinafter, the plate-shaped members 37e and 37f are also collectively referred to as the plate-shaped members 37.

Specifically, since the insulation layer 131e is laminated together with the insulation layers 31e, the plate-shaped member 37e is located between the second end surface 12 of the multilayer body 10 and the coil conductor 32a closest to the second end surface 12. In addition, since the insulation layers 131f are laminated together with the insulation layers 31f, the plate-shaped members 37f are located between the first end surface 11 of the multilayer body 10 and the coil conductor 32d closest to the first end surface 11. The dimension of the plate-shaped members 37 in the direction perpendicular to the coil axis is larger than the dimension in the direction parallel to the coil axis. Hence, it can be said that the shape of the plate-shaped member 37 is a plate shape extending in the same directions as the insulation layer 131. The plate-shaped member 37 covers only part of the insulation layer 131. Hence, the area of the plate-shaped member 37 is smaller than the area of the insulation layer 131 corresponding to the area of the first end surface 11 or the second end surface 12 of the multilayer body 10.

When the cross-sectional area of the coil is assumed to be 1, the area of the plate-shaped member should preferably be 1.63 or less, and it should more preferably be 0.18 or more and 1.40 or less (i.e., from 0.18 to 1.40). The area of the plate-shaped member is the area of the plate-shaped member viewed in the coil axis direction. In the case in which the number of plate-shaped members is two or more, the area of each plate-shaped member is measured, and the average of the measurement results is regarded as the area of the plate-shaped member.

The cross-sectional area of the coil is defined as the area calculated from the shape of the inner side portion (inner periphery) of the circling-shape portion of the coil.

In the exploded perspective view of the multilayer body illustrated in FIG. 2, the inner distance of the coil conductor in the width direction W of the multilayer body 10 is the length indicated by R_{W}, and the inner distance of the coil conductor in the height direction T of the multilayer body 10 is the length indicated by R_{T}. As for the shape of the plate-shaped members 37e and 37f viewed in the lamination direction of the multilayer body 10, when the lengths of the multilayer body 10 in the height direction T and the width direction W are expressed as L_{W} and L_{T}, respectively, L_{W} is equal to L_{T}, and thus, the shape of the plate-shaped members 37e and 37f is a square. The outer peripheral shape of the circling-shape portion of the coil is a square in which the length in the height direction T of the multilayer body 10 is R_{T}, and the length in the width direction is RW. Hence, the area of the plate-shaped member is expressed as L_{W}², L_{T}², or L_{W}×L_{T}, and the cross-sectional area of the coil is expressed as R_{T}×R_{W}.

When the cross-sectional area of the coil is assumed to be 1, the area of the plate-shaped member may be 1 or less. In the case in which the cross-sectional area of the plate-shaped member exceeds 1 when the cross-sectional area of the coil is assumed to be 1, the coil conductors included in the coil and the plate-shaped member overlap in the lamination direction, and there is a possibility that the size of the coil mark cannot be sufficiently reduced.

Hence, it is preferable that the outer peripheral shape of the plate-shaped member be similar to the inner peripheral shape of the circling-shape portion of the coil in transparent view of the multilayer body in the longitudinal direction. Because a coil mark is likely to be formed on the inner side of the circling-shape portion of the coil so as to have a shape similar to the inner periphery of the circling-shape portion of the coil, if the outer peripheral shape of the plate-shaped member is similar to the inner peripheral shape of the circling-shape portion of the coil, it makes easy to reduce the size of the coil mark.

In the exploded perspective view of the multilayer body illustrated in FIG. 2, the inner peripheral shape of the circling-shape portion of the coil is approximately a square, and the outer peripheral shape of the plate-shaped member is also approximately a square. Hence, it can be said that the outer peripheral shape of the plate-shaped member is similar to the inner peripheral shape of the circling-shape portion of the coil.

However, regardless of the inner peripheral shape of the circling-shape portion of the coil, a configuration in which the outer peripheral shape of the plate-shaped member is not similar to the inner peripheral shape of the circling-shape portion of the coil is possible. For example, when the inner peripheral shape of the circling-shape portion of the coil is approximately a square, the outer peripheral shape of the plate-shaped member may be approximately a circle, a pentagon, a rectangle, and the like. The size of the coil mark can be adjusted by appropriately changing the outer peripheral shape of the plate-shaped member as mentioned above relative to the inner peripheral shape of the circling-shape portion of the coil.

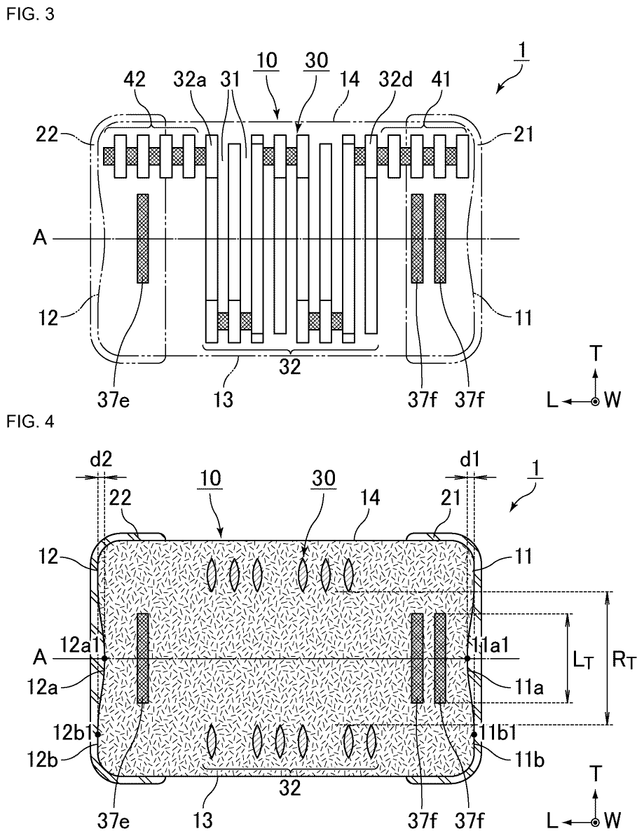

FIG. 3 is a transparent side view of the multilayer body included in the laminated coil component illustrated in FIG. 1, schematically illustrating an example of the internal structure.

As illustrated in FIG. 3, the plurality of insulation layers 31 are laminated in the longitudinal direction L in the laminated coil component 1, and hence, the longitudinal direction L is the lamination direction. The lamination direction of the multilayer body 10 and the coil axis A of the coil 30 are parallel to the mounting surface, which is one of the first main surface 13, the second main surface 14, the first side surface 15, and the second side surface 16, for example, the first main surface 13.

As illustrated in FIG. 3, no boundary is actually seen between adjoining insulation layers 31.

The first extension conductor 41 extends in the multilayer body 10 in the lamination direction to connect the first outer electrode 21 located on the first end surface 11 to the coil conductor 32a facing the first outer electrode 21 in a straight line. Similarly, the second extension conductor 42 extends in the multilayer body 10 in the lamination direction to connect the second outer electrode 22 located on the second end surface 12 to the coil conductor 32d facing the second outer electrode 22 in a straight line.

Although it is preferable that the via conductors included in the extension conductor overlap one another when viewed in the lamination direction (the longitudinal direction L), the via conductors included in the extension conductor need not be aligned strictly in a straight line.

Although FIGS. 2 and 3 illustrate an example in which the number of laminated coil conductors 32 for forming three turns of the coil 30 is four, in other words, an example in which the repeated shape is a three-quarters turn shape, the number of laminated coil conductors 32 for forming one turn of the coil 30 is not particularly limited. For example, the number of laminated coil conductors 32 for forming one turn of the coil 30 may be two, in other words, the repeated shape may be a half turn shape.

Although the number of laminated coil conductors 32, in other words, the total number of laminated coil conductors 32 included in the multilayer body 10 is not particularly limited, it should preferably be 30 or more and 120 or less (i.e., from 30 to 120). In the case in which the total number of laminated coil conductors included in the multilayer body is 50 or more, the multilayer body is likely to have a coil mark in the first end surface. Hence, the laminated coil conductor of the present disclosure is suitable to such configurations.

FIG. 4 is a cross-sectional view of the laminated coil component illustrated in FIG. 1, schematically illustrating an example of the cross section taken along line segment A1-A1.

When a cross section in a direction perpendicular to the extending direction of the coil conductor 32 is viewed as illustrated in FIG. 4, the cross-sectional shape of the coil conductor 32 is a compressed shape (an elongated shape), the longitudinal direction of which is orthogonal to the lamination direction (the longitudinal direction L). Although the cross-sectional shape of the coil conductor 32 is an elliptical shape the major axis of which is orthogonal to the lamination direction in the example illustrated in FIG. 4, the cross-sectional shape of the coil conductor 32 is not particularly limited. For example, the cross-sectional shape of the coil conductor 32 may be a rectangular shape in which the lengths of the pair of sides facing each other in the lamination direction are the same, a trapezoidal shape in which the lengths of the pair of sides facing each other in the lamination direction are different, or other shapes.

The multilayer body 10 illustrated in FIG. 4 include two plate-shaped members 37f between the first end surface 11 of the multilayer body 10 and the coil conductor 32d closest to the first end surface 11. This is because the insulation layers for forming the first extension conductor 41 include the insulation layers 131f each provided with not only the via conductor 33f and the pad 35f but also the plate-shaped member 37f, as illustrated in FIG. 2.

Since the multilayer body 10 includes the plate-shaped members 37f, the shape of the first end surface 11 of the multilayer body 10 can be adjusted. Specifically, since the plate-shaped members 37f are included, a first depression 11a that occurs in the first end surface 11 of the multilayer body 10 can be smaller according to the thickness of the plate-shaped members 37f. Hence, the depth d1 of the first depression 11a that occurs in the first end surface 11 of the multilayer body 10 can be smaller than configurations without plate-shaped members 37f. Note that the depth d1 of the first depression 11a is defined as the length, in the lamination direction, from the deepest portion 11al of the first depression 11a in the first end surface 11 to the peak 11b1 of a first protuberance 11b where the first end surface 11 bulges. The first depression 11a illustrated in FIG. 4 results from the occurrence of a coil mark in the first end surface 11 of the multilayer body 10. Since the coil mark is formed at the position overlapping the circling-shape portions of the coil in transparent view of the multilayer body 10 in the longitudinal direction L, it can be said that the shape of the first depression 11a is a shape formed by recessing the portion of the first end surface 11 of the multilayer body 10 inside the portion overlapping the circling-shape portions of the coil, toward the second end surface 12.

FIG. 4 is also a cross section taken along a plane parallel to the longitudinal direction L and the height direction T of the multilayer body 10 at the center of the multilayer body 10 in the width direction W. Each of the outer peripheral shapes of the plate-shaped members 37e and 37f and the inner peripheral shape of the circling-shape portions of the coil 30 may be a square the dimensions of which in the height direction T and the width direction W are equal. Hence, in this case, the cross-sectional area of the coil 30 illustrated in FIG. 4 is R_{T}², and the area of the plate-shaped members 37e and 37f is L_{T}². Since R_{T}>L_{T} according to FIG. 4, it can be said that when the cross-sectional area R_{T}² of the coil 30 is assumed to be 1, the area L_{T}² of the plate-shaped members 37e and 37f is 1 or less.

The multilayer body 10 illustrated in FIG. 4 includes one plate-shaped member 37e between the second end surface 12 of the multilayer body 10 and the coil conductor 32a closest to the second end surface 12. This is because the insulation layers for forming the second extension conductor 42 include the insulation layer 131e provided with not only the via conductor 33e and the pad 35e but also the plate-shaped member 37e, as illustrated in FIG. 2.

Since the multilayer body 10 includes the plate-shaped member 37e, the shape of the second end surface 12 of the multilayer body 10 can be adjusted. Specifically, since the plate-shaped member 37e is included, a second depression 12a that occurs in the second end surface 12 of the multilayer body 10 can be smaller according to the thickness of the plate-shaped member 37. Hence, the depth d₂ of the second depression 12a that occurs in the second end surface 12 of the multilayer body 10 can be smaller than configurations without plate-shaped members 37e. Note that the depth d₂ of the second depression 12a is defined as the length, in the lamination direction, from the deepest portion 12al of the second depression 12a in the second end surface 12 to the peak 12b1 of a second protuberance 12b where the second end surface 12 bulges. The second depression 12a illustrated in FIG. 4 results from the occurrence of a coil mark in the second end surface 12 of the multilayer body 10. Since the coil mark is formed at the position overlapping the circling-shape portions of the coil in transparent view of the multilayer body 10 in the longitudinal direction L, it can be said that the shape of the second depression 12a is a shape formed by recessing the portion of the second end surface 12 of the multilayer body 10 inside the portion overlapping the circling-shape portions of the coil, toward the first end surface 11.

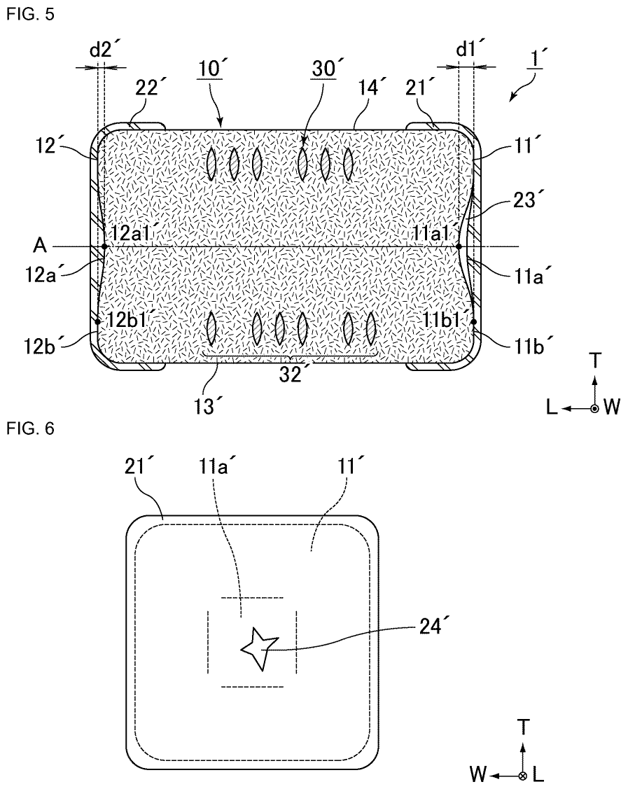

The shapes of the first and second end surfaces of the multilayer body in a case with plate-shaped members and in a case without plate-shaped members will be described with reference to FIG. 5. FIG. 5 is a schematic cross-sectional view of an example of a laminated coil component without plate-shaped members. The laminated coil component 1′ illustrated in FIG. 5 is also an example in which the insulation layers 31e and 31f are used instead of the insulation layers 131e and 131f in the laminated coil component of the exploded perspective view illustrated in FIG. 2. Specifically, it is an example in which the multilayer body does not include plate-shaped members 37.

As illustrated in FIG. 5, the first end surface 11′ of the multilayer body 10′ included in the laminated coil component 1′ has a first depression 11a′ with a depth of d₁′. The second end surface 12′ of the multilayer body 10′ has a second depression 12a′ with a depth of d₂′. The depth d₁′ of the first depression 11a′ formed in the first end surface 11′ of the multilayer body 10′ included in the laminated coil component 1′ is larger than the depth d₁ of the first depression 11a formed in the first end surface 11 of the multilayer body 10 included in the laminated coil component 1 illustrated in FIG. 4.

Since the first depression 11a′ in the first end surface 11′ is deep in the laminated coil component l′ illustrated in FIG. 5, a void 23′ is formed between the first outer electrode 21′ and the first depression 11a′.

FIG. 6 is a side view of the laminated coil component illustrated in FIG. 5, from the first end surface side. As can be seen from FIG. 6, the surface of the first outer electrode 21′ formed on the first end surface 11′ has a crack 24′ resulting from the void 23′ illustrated in FIG. 5.

In contrast, in the laminated coil component 1 illustrated in FIG. 4, since the multilayer body 10 has the plate-shaped members 37, the depression formed in the first end surface 11 which is an end surface on which an outer electrode is formed can be small (shallow), it reduces defects in forming the outer electrode.

The depth of the depression in the first end surface and the depth of the depression in the second end surface may be the same in the multilayer body or may be different. However, it is preferable that the depth difference between the depressions in the first end surface and the second end surface be 12 μm or less. If the depth difference between the depressions in the first end surface and the second end surface is 12 μm or less, variations in the shapes of the laminated coil component on the first end surface side and on the second end surface side can be reduced.

In the laminated coil component illustrated in FIGS. 2 to 4, it is preferable that the difference between the depth d1 of the first depression in the first end surface 11 and the depth d2 of the second depression in the second end surface be 12 μm or less.

Note that the depth of the first depression in the first end surface is measured as follows. A multilayer body is ground from a main surface (L_{T} surface) of the multilayer body to the center in the width direction W to expose an L_{T} cross section. A cross-sectional image of the cross section is obtained by using a digital microscope or the like. The difference in dimension between the lowest portion (the most depressed portion) in the insulation layer and the highest portion (the most bulging portion, which corresponds to the peak of the first protuberance) in the longitudinal direction Lis measured by using a parallel-dimension measurement instrument or the like. The depth of the second depression in the second end surface can be measured by the same as or similar procedure.

A plate-shaped member may be located between the coil conductor closest to the first end surface of the multilayer body and the first end surface in the longitudinal direction of the multilayer body. If a plate-shaped member is located between the coil conductor closest to the first end surface of the multilayer body and the first end surface, it can prevent the plate-shaped member from coming off the multilayer body and effectively reduce the depth of the first depression. For example, in the laminated coil component 1 illustrated in FIGS. 2 to 4, the plate-shaped members 37f are located between the coil conductor 32d closest to the first end surface 11 of the multilayer body 10 and the first end surface 11 of the multilayer body 10.

A plate-shaped member may be located between the coil conductor closest to the second end surface of the multilayer body and the second end surface in the longitudinal direction of the multilayer body. For example, in the laminated coil component 1 illustrated in FIGS. 2 to 4, the plate-shaped member 37e is located between the coil conductor 32a closest to the second end surface 12 of the multilayer body 10 and the second end surface 12 of the multilayer body 10.

It is preferable that a plate-shaped member be located at a position where the plate-shaped member is exposed on the first end surface of the multilayer body. Note that “being exposed on the first end surface of the multilayer body” denotes that a plate-shaped member is exposed from the multilayer body and does not necessarily denote that a plate-shaped member is exposed on a surface of the laminated coil component. Specifically, part or all of the plate-shaped member exposed from the first end portion of the multilayer body may be covered with, for example, the first outer electrode or the like other than the multilayer body. In this case, it is preferable that the first outer electrode cover at least part of the plate-shaped member.

The closer to the first end surface of the multilayer body the plate-shaped member is located, the higher the effect of reducing the coil mark is. Hence, if a plate-shaped member is located at a position where the plate-shaped member is exposed on the first end surface of the multilayer body, the effect of the plate-shaped member reducing the coil mark is particularly high. In addition, if the first outer electrode covers at least part of the plate-shaped member, it is easy to reduce defects in forming the outer electrode, caused by the coil mark.

A plate-shaped member may be provided inside the coil. In this case, when the cross-sectional area of the coil is assumed to be 1, it is preferable that the area of the plate-shaped member in the height direction and the width direction be less than 1. In the case in which the area of the plate-shaped member in the height direction and the width direction is less than 1 when the cross-sectional area of the coil is assumed to be 1, the plate-shaped member can be located within the inner side of the circling-shape portion of the coil in transparent view of the multilayer body in the longitudinal direction. Hence, it is possible to efficiently reduce the depth of the depression in the first end surface of the multilayer body.

The number of plate-shaped members may be two or more. By changing the number of plate-shaped members, it is possible to adjust the size of the coil mark.

For example, the multilayer body 10 included in the laminated coil component 1 illustrated in FIGS. 2 to 4 includes three plate-shaped members in total. If the number of plate-shaped members is two or more, the coil mark can be reduced further than the configuration having one plate-shaped member 1.

In the case in which the number of plate-shaped members is two or more, it is preferable that at least one plate-shaped member be located between the coil conductor closest to the first end surface and the first end surface in the longitudinal direction and that at least one plate-shaped member be located between the coil conductor closest to the second end surface and the second end surface in the longitudinal direction. If plate-shaped members are located at the positions mentioned above, the coil mark can be reduced not only in the first end surface but also in the second end surface in the multilayer body.

For example, in the laminated coil component 1 illustrated in FIGS. 2 to 4, one plate-shaped member 37e is located between the coil conductor 32a closest to the first end surface 11 of the multilayer body 10 and the first end surface 11 of the multilayer body 10, and two plate-shaped members 37f are located between the coil conductor 32d closest to the second end surface 12 of the multilayer body 10 and the second end surface 12 of the multilayer body 10.

In the case in which the number of plate-shaped members is two or more, when the multilayer body is assumed to be bisected in the longitudinal direction into a region on the first end surface side and a region on the second end surface side, it is preferable that at least one plate-shaped member be located in both the region on the first end surface side and the region on the second end surface side. In this case, the number of plate-shaped members may be the same in both the region on the first end surface side and the region on the second end surface side, but it is preferable that they be different. The plate-shaped member located in the region on the first end surface side is likely to contribute to reducing the coil mark on the first end surface, and the plate-shaped member located in the region on the second end surface side is likely to contribute to reducing the coil mark on the second end surface. Hence, in the case in which two or more plate-shaped members are located in the positions mentioned above, they can reduce not only the coil mark on the first end surface of the multilayer body but also the coil mark on the second end surface. In the step of laminating insulation layers, in general, a plurality of insulation layers are laminated on a base with the lamination direction aligned with the vertical direction. One of the first end surface and the second end surface located on the base side is surface-supported, and the other is not supported. Hence, in the case of a configuration without plate-shaped members, the depths of the coil marks on the first end surface and the second end surface of the multilayer body can be asymmetric in some cases because only the end surface on the one side is pressed against the base. Hence, in the case in which the number of plate-shaped members differs between the region on the first end surface side and the region on the second end surface side, the depth of the depression in the first end surface and the depth of the depression in the second end surface can be independently reduced. Hence, it is possible to reduce the difference in the size of the depression between the first end surface and the second end surface of the multilayer body.

For example, as for the laminated coil component 1 illustrated in FIGS. 2 to 4, it can be said that, of the eight laminated insulation layers 31a, 31b, 31c, and 31d, the insulation layer 31d which is the fourth layer from the bottom and the layers below this insulation layer 31d belong to the region on the first end surface 11 side of the multilayer body 10. Similarly, it can be said that, of the eight laminated insulation layers 31a, 31b, 31c, and 31d, the insulation layer 31a which is the fifth layer from the bottom and the layers above this insulation layer 31a belong to the region on the second end surface 12 side of the multilayer body 10. Hence, as for the laminated coil component 1 illustrated in FIGS. 2 to 4, it can be said that one plate-shaped member 37e is located in the region on the first end surface 11, and that two plate-shaped members 37f are located in the region on the second end surface 12. It can also be said that the number of plate-shaped members located in the region on the first end surface side differs from the number of plate-shaped members located in the region on the second end surface side.

It is preferable that the thickness of each plate-shaped member be 15 μm or more and 40 μm or less (i.e., from 15 μm to 40 μm). When the multilayer body is assumed to be divided at the center of the multilayer body in the lamination direction, it is preferable that the total thickness of plate-shaped members located in each of the region on the first end surface side and the region on the second end surface side be 20 μm or more and 150 μm or less (i.e., from 20 μm to 150 μm). In addition, in the lamination direction, each of the total thickness of plate-shaped members located in the region closer to the first end surface than the coil conductor closest to the first end surface and the total thickness of plate-shaped members located in the region closer to the second end surface than the coil conductor closest to the second end surface be 20 μm or more and 150 μm or less (i.e., from 20 μm to 150 μm).

The material of the plate-shaped member is not particularly limited but should preferably be an inorganic material. In the case in which plate-shaped members are contained inside in the multilayer body, and plate-shaped members are composed of an inorganic material, the volume change when they are sintered is small, which makes it easy to adjust depressions by using plate-shaped members. In the case in which a plate-shaped member is exposed from the multilayer body, it is conceivable that the plate-shaped member can be provided after the multilayer body is sintered, and an organic material may be used for the plate-shaped member. However, since inorganic materials in general have high heat resistance and high chemical resistance, it is preferable that plate-shaped members be composed of an inorganic material. Examples of the inorganic materials include ceramic materials and metal materials.

Examples of the ceramic materials include crystalline materials such as ferrite, alumina, and zirconia materials; amorphous materials such as borosilicate glass materials; and glass ceramic materials.

Examples of the metal materials include Ag, Au, Cu, Pd, Ni, Al, and alloys containing at least one of these metals. In addition, for example, if materials (for example, alumina and Cu) more inexpensive than the metal material (for example, Ag) composing the internal electrodes (coil conductors) are used as the inorganic materials such as ceramic materials and metal materials, the costs for reducing the size of the coil mark can be lower.

It is preferable that the plate-shaped members contain the same metal element as the coil.

Plate-shaped members may be composed of a metal and electrically connected to the coil. In the case in which plate-shaped members are composed of a metal and electrically connected to the coil, the plate-shaped members can be used for adjusting the electrostatic capacity of the laminated coil component. Specifically, in the case in which plate-shaped members are composed of a metal and electrically connected to the coil, an electrostatic capacity occurs between the plate-shaped members and the coil and between the plate-shaped members and the outer electrodes. In the case in which a laminated coil component includes two or more plate-shaped members composed of a metal, an electrostatic capacity occurs between the plate-shaped members. The electrostatic capacity mentioned above works as a series capacitor, which reduces the electrostatic capacity of the laminated coil component as a whole. This increases the impedance value at frequencies higher than or equal to the self-resonant frequency.

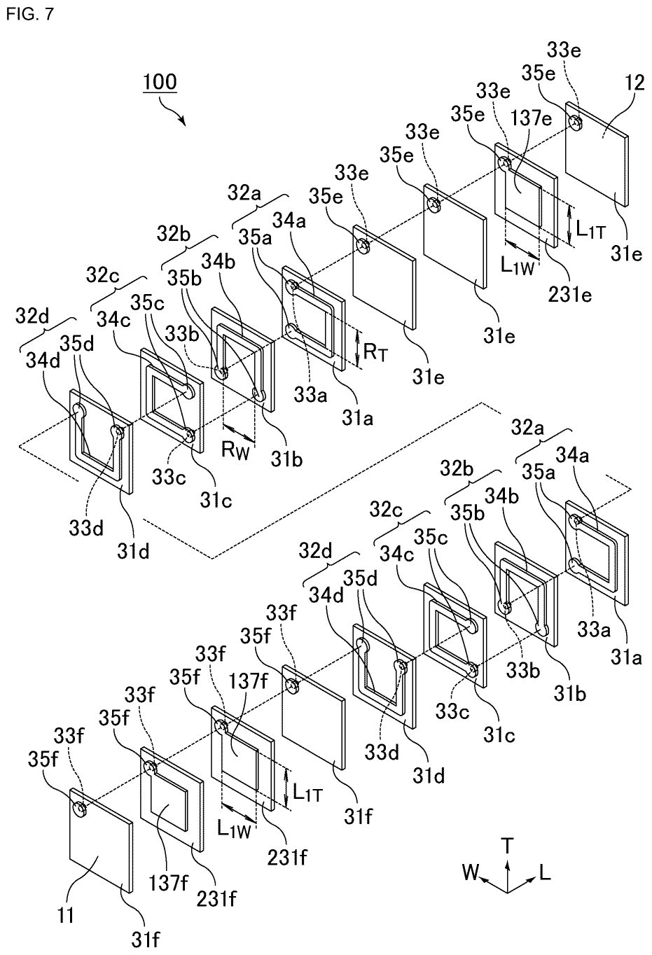

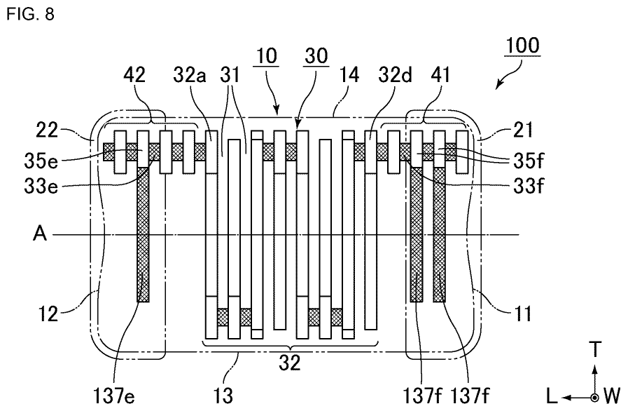

The plate-shaped members may be directly connected to the coil or pads or may be connected to the coil with via conductors interposed therebetween. For example, as illustrated in FIGS. 7 and 8 described later, part of a pad may be integrated with a plate-shaped member. Alternatively, although not illustrated, all of a pad may be integrated with a plate-shaped member. In the case in which a plate-shaped member is integrated with a pad located on the same layer, the area of the pad is included in the area of the plate-shaped member in calculation.

FIG. 7 is a schematic exploded view of another example of a multilayer body included in a laminated coil component of the present disclosure. The exploded view illustrated in FIG. 7 differs from the exploded view illustrated in FIG. 2 in that the area of each plate-shaped member is larger. Specifically, the insulation layers 131e and 131f having the plate-shaped members 37e and 37f with a dimension of L_{T} in the height direction T and a dimension of L_{W} in the width direction W in the multilayer body 10 illustrated in FIG. 2 are changed to insulation layers 231e and 231f having plate-shaped members 137e and 137f with a dimension of LIT in the height direction T and a dimension of L_{1W} in the width direction W in the multilayer body 100 illustrated in FIG. 7. The dimension L_{1T} of the plate-shaped members 137e and 137f in the height direction is larger than the dimension R_{T} of the inner peripheral shape of the circling-shape portions of the coil in the height direction T. Similarly, the dimension L_{1W} of the plate-shaped members 137e and 137f in the width direction W is larger than the dimension R_{W} of the inner peripheral shape of the circling-shape portions of the coil in the width direction W. Hence, it can be said that parts of the pads 35e and 35f are integrated with the plate-shaped members 137e and 137f. In this case, the areas of the pads 35e and 35f are included in the areas of the plate-shaped members 137e and 137f.

FIG. 8 is a transparent side view of the multilayer body illustrated in FIG. 7, schematically illustrating an example of the internal structure. As illustrated in FIG. 8, the multilayer body 100 has a configuration the same as or similar to the multilayer body 10 illustrated in FIG. 3 except that the plate-shaped members are larger and integrated with parts of the pads. The plate-shaped members 137e and 137f are composed of a metal. In this case, the plate-shaped members 137e and 137f are electrically connected to the pads 35e and 35f and the via conductors 33e and 33f, respectively. It can be said that the plate-shaped members 137e and 137f are electrically connected to the coil 30 with the pads 35e and 35f and the via conductors 33e and 33f interposed therebetween.

Note that in the case in which the size of the plate-shaped members is larger than the size in FIGS. 7 and 8 so that the outer shapes of the pads cannot be recognized, the pads are considered to be completely integrated with the plate-shaped members.

Configurations in which plate-shaped members composed of a conductive metal are not electrically connected to the coil are also possible. In the case in which plate-shaped members composed of a conductive metal are not electrically connected to the coil, the plate-shaped members function as an iron core. Hence, the inductance of the laminated coil component can be adjusted by adjusting the magnetic permeability of the plate-shaped members.

It is preferable that plate-shaped members contain the same ceramic material as the insulation layers.

Plate-shaped member may have the same composition as the coil or may have the same composition as the insulation layers.

Examples of the materials composing the insulation layers include magnetic materials such as magnetic ferrite materials and non-magnetic materials such as borosilicate glass materials. A magnetic material and a non-magnetic material may be used in parallel. It is preferable that the ferrite materials be Ni—Cu—Zn ferrite materials.

The material composing the coil conductors needs only to be a conductive material, examples of which include Ag, Au, Cu, Pd, Ni, Al, and alloys containing at least one of these metals.

Hereinafter, another example of the structure of a multilayer body included in a laminated coil component of the present disclosure will be described with reference to an exploded perspective view similar to FIG. 2.

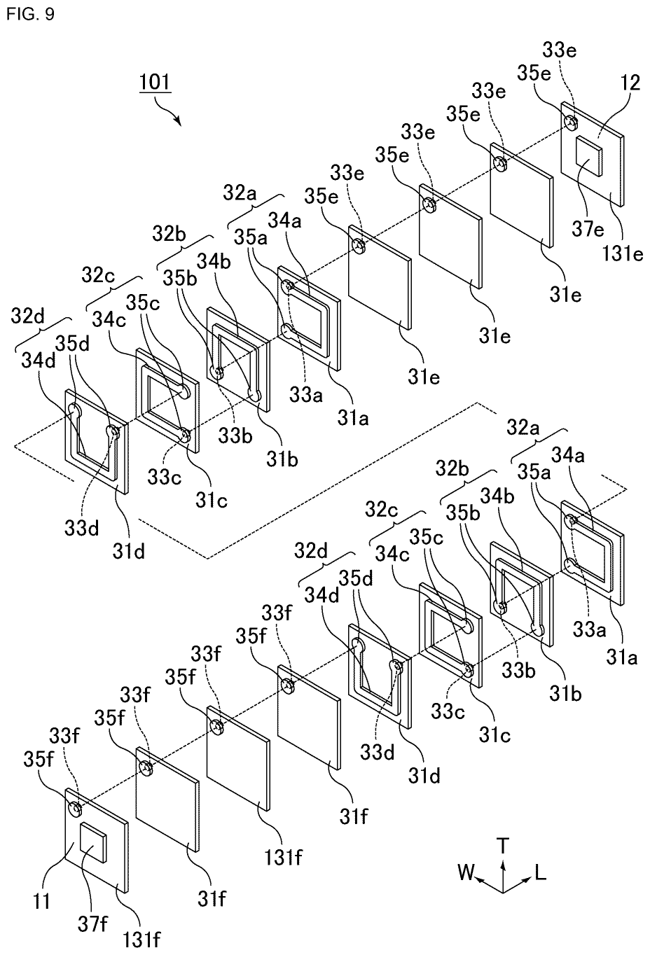

FIG. 9 is a schematic exploded view of another example of a multilayer body included in a laminated coil component of the present disclosure. The multilayer body 101 illustrated in FIG. 9 corresponds to one in which out of the insulation layers included in the multilayer body 10 illustrated in FIG. 2, further out of the four insulation layers 31e and 131e composing the second extension conductor, the first insulation layer from the second end surface 12 is changed from an insulation layer 31e to an insulation layer 131e, and the second insulation layer from the second end surface 12 is changed from an insulation layer 131e to an insulation layer 31e, and out of the four insulation layers 31f and 131f composing the first extension conductor, the first insulation layer 31f from the first end surface 11 is changed to an insulation layer 131ef, and the second and third insulation layers 131f from the first end surface 11 are changed to insulation layers 31f. A plate-shaped member 37e is located between the coil conductor 32a closest to the second end surface 12 and the second end surface 12. A plate-shaped member 37f is exposed on the first end surface 11 of the multilayer body 10.

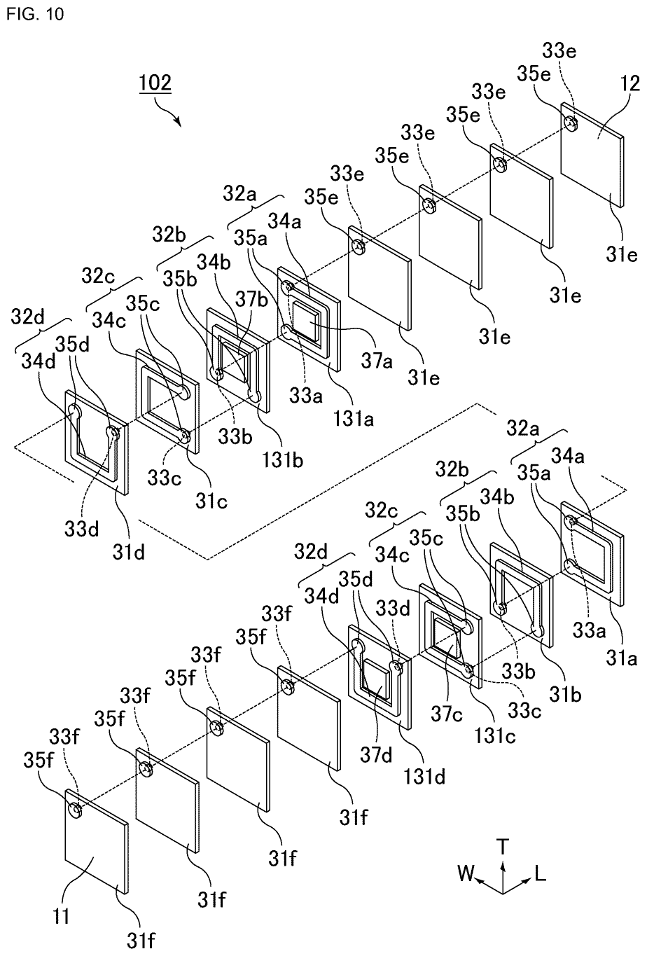

FIG. 10 is a schematic exploded view of still another example of a multilayer body included in a laminated coil component of the present disclosure. The multilayer body 102 illustrated in FIG. 10 corresponds to one in which out of the insulation layers included in the multilayer body 10 illustrated in FIG. 2, the first, second, seventh, and eighth insulation layers 31a, 31b, 31c, and 31d from the first end surface 11 are changed to insulation layers 131a, 131b, 131c, and 131d, respectively. The insulation layer 131ea is provided with a via conductor 33a, a pad 35a, and a plate-shaped member 37a. The insulation layer 131b is provided with a via conductor 33b, a pad 35b, and a plate-shaped member 37b. The insulation layer 131c is provided with a via conductor 33c, a pad 35c, and a plate-shaped member 37c. The insulation layer 131d is provided with a via conductor 33d, a pad 35d, and a plate-shaped member 37d. Each of the four plate-shaped members 37a, 37b, 37c, and 37d is located on the inner side of a spiral forming the coil, in other words, inside the coil.

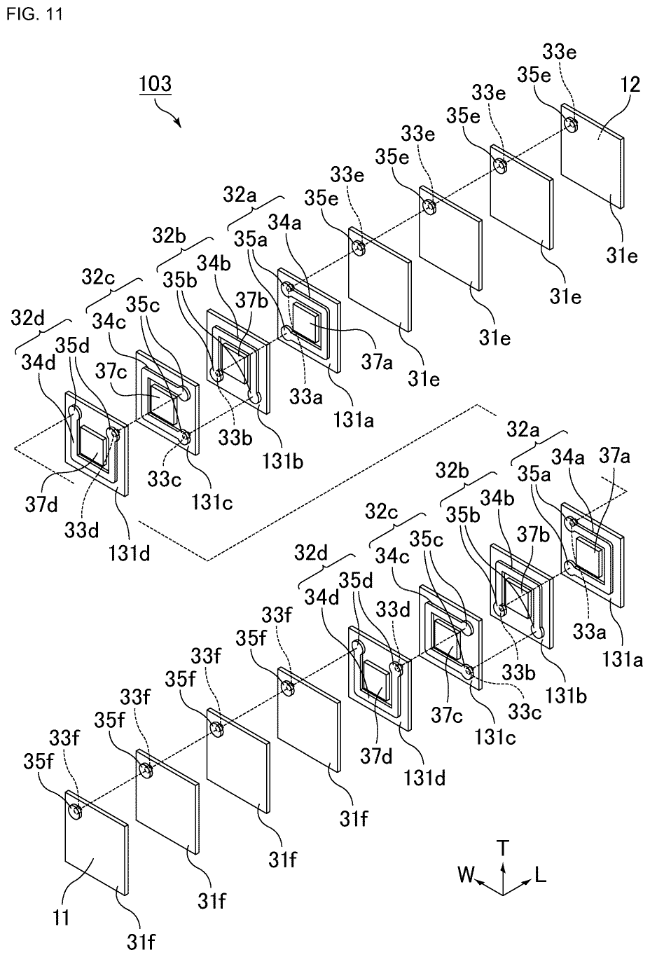

FIG. 11 is a schematic exploded view of still another example of a multilayer body included in a laminated coil component of the present disclosure. FIG. 11 is an example in which each of the insulation layers corresponding to the coil sheets has a plate-shaped member. Hence, two each of the plate-shaped members 37a, 37b, 37c, and 37d are located inside the coil included in the multilayer body 103.

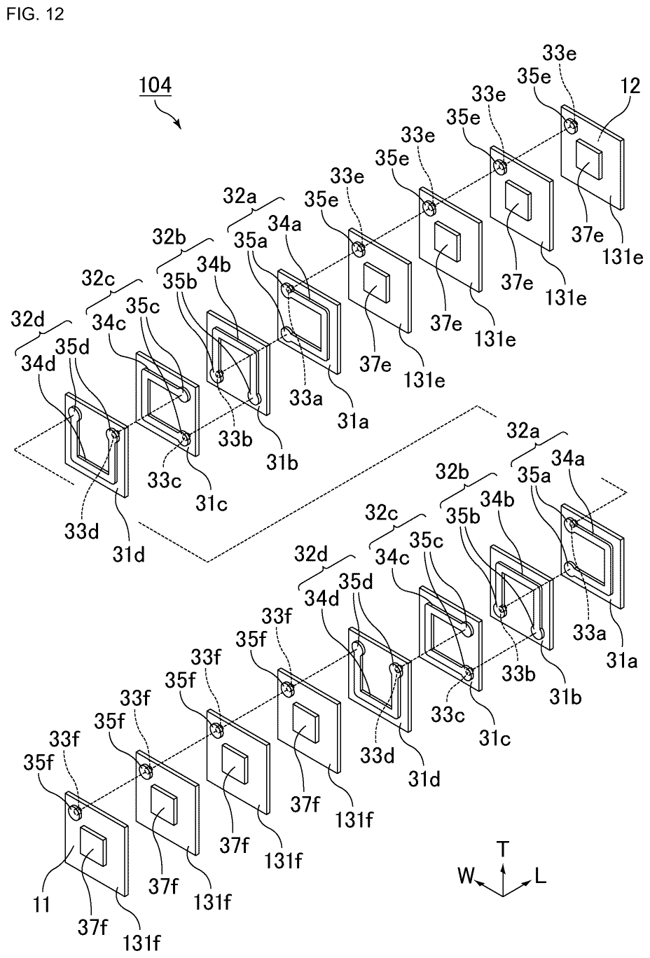

FIG. 12 is a schematic exploded view of still another example of a multilayer body included in a laminated coil component of the present disclosure. FIG. 12 is an example in which each of the insulation layers corresponding to the via sheets has a plate-shaped member. Hence, four plate-shaped members 37e are located between the coil conductor 32a closest to the second end surface 12 of the multilayer body 104 and the second end surface 12 of the multilayer body 104, and three plate-shaped members 37f are located between the coil conductor 32d closest to the first end surface 11 of the multilayer body 104 and the first end surface 11 of the multilayer body 104. One plate-shaped member 37f is exposed on the first end surface 11 of the multilayer body 104.

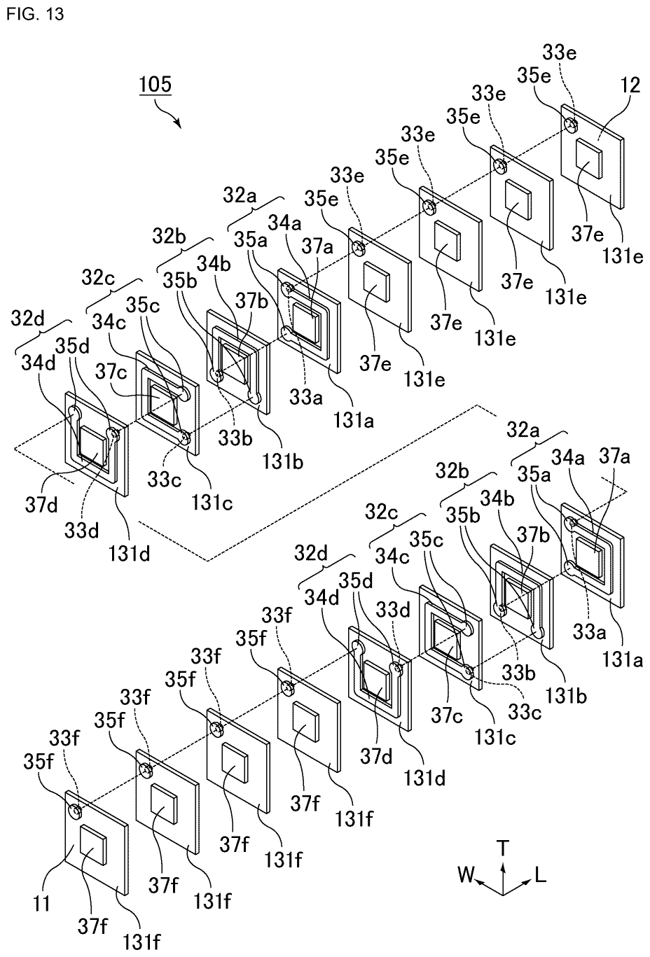

FIG. 13 is a schematic exploded view of still another example of a multilayer body included in a laminated coil component of the present disclosure. FIG. 13 illustrates an example in which each of the insulation layers included in the multilayer body has a plate-shaped member. Hence, four plate-shaped members 37e are located between the coil conductor 32a closest to the second end surface 12 of the multilayer body 105 and the second end surface 12 of the multilayer body 105. Three plate-shaped members 37f are located between the coil conductor 32d closest to the first end surface 11 of the multilayer body 105 and the first end surface 11 of the multilayer body 105. One plate-shaped member 37f is exposed on the first end surface 11 of the multilayer body 104. Two each of the plate-shaped members 37a, 37b, 37c, and 37d are located inside the coil.

### Method of Manufacturing Laminated Coil Component

A method of manufacturing a laminated coil component of the present disclosure includes a step of preparing ceramic green sheets containing a ceramic material; a print step of applying a conductor paste serving as a coil conductor layer and/or a via conductor to the ceramic green sheets; a step of producing an unsintered multilayer body including an unsintered coil by laminating the ceramic green sheets on which the coil conductor layer is formed; and a step of producing a multilayer body by sintering the unsintered multilayer body. The step of producing an unsintered multilayer body or the print step includes a step of providing a layer containing an inorganic material and having a smaller area than the ceramic green sheets.

The following describes an example of a method of manufacturing a laminated coil component of the present disclosure.

### Preparation of Magnetic Material

First, Fe₂O₃, ZnO, CuO, and NiO are weighed out to have a specified ratio.

Next, these weighed materials, pure water, and the like are placed together with partially stabilized zirconia (PSZ) media into a ball mill, mixed, and then pulverized. Mixing and pulverizing time is set to, for example, 4 hours or more and 8 hours or less (i.e., from 4 hours to 8 hours).

Then, the resultant pulverized material is dried and pre-sintered. The pre-sintering temperature is set to, for example, 700° C. or higher and 800° C. or lower (i.e., from 700° C. to 800° C.). The pre-sintering time is set to, for example, 2 hours or more and 5 hours or less (i.e., from 2 hours to 5 hours).

Thus, a powdery magnetic material, more specifically, a powdery magnetic ferrite material is prepared.

It is preferable that the ferrite material be a Ni—Cu—Zn ferrite material.

As for the Ni—Cu—Zn ferrite material, when the total amount is assumed to be 100 mol %, it is preferable that the Fe₂O₃ content for Fe be 40 mol % or more and 49.5 mol % or less (i.e., from 40 mol % to 49.5 mol %), the ZnO content for Zn be 2 mol % or more and 35 mol % or less (i.e., from 2 mol % to 35 mol %), the CuO content for Cu be 6 mol % or more and 13 mol % or less (i.e., from 6 mol % to 13 mol %), and the NiO content for Ni be 10 mol % or more and 45 mol % or less (i.e., from 10 mol % to 45 mol %).

The Ni—Cu—Zn ferrite material may further contain an additive such as Co, Bi, Sn, and Mn.

The Ni—Cu—Zn ferrite material may further contain inevitable impurities.

### Step of Preparing Ceramic Green Sheets

First, a ceramic material, an organic binder such as a polyvinyl butyral based resin, an organic solvent such as ethanol or toluene, a plasticizer, and the like are placed together with PSZ media into a ball mill, mixed, and then pulverized to prepare a slurry. For the ceramic material, the aforementioned magnetic material can be used.

Next, the slurry is formed into a sheet with a specified thickness by a doctor blade process or the like and then punched into a specified shape to produce ceramic green sheets. The thickness of the ceramic green sheets is set to, for example, 20 μm or more and 30 μm or less (i.e., from 20 μm to 30 μm). The shape of the ceramic green sheet is, for example, rectangular.

The material of the ceramic green sheets may be a non-magnetic material such as a borosilicate glass material instead of a magnetic material or may be a mixed material containing a magnetic material and a non-magnetic material.

First, via holes are formed by irradiating a specified point on the ceramic green sheets with a laser.

### Print Step

Next, a conductive paste such as a Ag paste is applied to surfaces of the ceramic green sheets by a screen printing or the like while filling the via holes. With this step, conductor portions for via conductors are formed in the via holes in the ceramic green sheets, and conductor patterns for coil conductors connected to the conductor portions for the via conductors are formed on surfaces of the ceramic green sheets. Thus, coil sheets, which are ceramic green sheets having conductor patterns for coil conductors and conductor portions for via conductors, are produced. On the coil sheets, conductor patterns for coil conductors corresponding to the coil conductors 32 illustrated in FIG. 2 and conductor portions for via conductors corresponding to the via conductors 33 illustrated in FIG. 2 (excluding the via conductors 33e and 33f) are formed. Separately from the coil sheets, via sheets having conductor portions for via conductors corresponding to the via conductors 33e and 33f illustrated in FIG. 2 are produced.

### Step of Producing Unsintered Multilayer Body

Coil sheets and via sheets are stacked in the order illustrated in FIG. 2 in the lamination direction (the longitudinal direction L) and then thermal-pressure-bonded to produce an unsintered multilayer body block.

### Step of Providing Layer Containing Inorganic Material

A step of providing layers containing an inorganic material is performed in the step of producing an unsintered multilayer body or the print step. The step of providing layers containing an inorganic material may be a step of applying a paste containing an inorganic material on parts of surfaces of ceramic green sheets. The paste containing an inorganic material applied to the parts of the surfaces of the ceramic green sheets are placed in an unsintered multilayer body when the ceramic green sheets are laminated. When the unsintered multilayer body is sintered, the paste turns to plate-shaped members. In other words, a step of applying the paste containing an inorganic material to parts of surfaces of ceramic green sheets enables plate-shaped members to be provided in a multilayer body. Note that when to perform the step of applying a paste containing an inorganic material to parts of surfaces of ceramic green sheets is not particularly limited within the print step. It may be performed simultaneously with, before, or after printing conductor patterns for coil conductors and conductor portions for via conductors. In any case, it can be said that the step of applying a paste containing an inorganic material to parts of surfaces of ceramic green sheets is performed in the print step.

In this process, a paste containing an inorganic material may be applied to coil sheets or via sheets. It is preferable that the paste containing an inorganic material be applied to a region on the inner side of the circling-shape portions of a coil.

In the step of providing layers containing an inorganic material, the paste applied to parts of surfaces of ceramic green sheets may contain the same ceramic material as the ceramic green sheets or may contain the same metal element as the conductor paste serving as the coil conductor layers.

The step of providing layers containing an inorganic material may be a step of laminating solid plate-shaped members together with the ceramic green sheets in the step of producing an unsintered multilayer body. By laminating solid plate-shaped members together with the ceramic green sheets in the step of producing an unsintered multilayer body, it is possible to obtain a sintered multilayer body with the plate-shaped members inside.

In the step of producing an unsintered multilayer body, the solid plate-shaped members in the step of laminating solid plate-shaped members together with the ceramic green sheets may contain the same ceramic material as the ceramic green sheets or may contain the same metal element as the conductor paste serving as the coil conductor layers.

### Step of Producing Multilayer Body and Coil

A multilayer body block is cut into pieces with a specified size by using a dicer or the like to produce individual chips.

Next, individual chips are sintered. The sintering temperature is set to, for example, 900° C. or higher and 920° C. or lower (i.e., from 900° C. to 920° C.). The sintering time is set to, for example, 2 hours or more and 4 hours or less (i.e., from 2 hours to 4 hours).

When the individual chips are sintered, ceramic green sheets for coil sheets and via sheets turn to insulation layers.

In addition, when individual chips are sintered, conductor patterns for coil conductors and conductor portions for via conductors turn to coil conductors and via conductors, respectively. The process described above produces a coil composed of a plurality of coil conductors laminated together with insulation layers and electrically connected to one another with the via conductors interposed therebetween.

The process above produces a multilayer body including a plurality of insulation layers laminated in the lamination direction and including a coil inside.

The multilayer bodies may be, for example, barrel polished to make the corners and the ridge lines rounded.

### Step of Forming Outer Electrodes

First, a conductive paste such as a paste containing Ag and glass frit is applied to the first end surface and the second end surface to which the coil is extended, out of the outer surfaces of the multilayer body, to form conductive paste layers.

Next, the conductive paste layers are baked to form underlying electrodes for outer electrodes. The baking temperature is set to, for example, 800° C. or higher and 820° C. or lower (i.e., from 800° C. to 820° C.). The thickness of the underlying electrodes is set to, for example, 5 μm.

Next, a Ni-plated electrode and a Sn-plated electrode are formed in this order on the surfaces of the underlying electrodes by electrolytic plating or the like. This process forms the outer electrodes each including an underlying electrode, a Ni plated electrode, and a Sn plated electrode in this order.

A laminated coil component is manufactured through the above processes.

The present specification describes the following items.

The disclosure (1) is a laminated coil component including a multilayer body including a plurality of laminated insulation layers and including a coil inside; and first and second outer electrodes electrically connected to the coil. The coil is composed of a plurality of coil conductors laminated together with the insulation layers and electrically connected to one another. The multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction. A coil axis of the coil is parallel to the first main surface. The multilayer body further includes a plate-shaped member laminated together with the insulation layers, a dimension of the plate-shaped member in a direction perpendicular to the coil axis being larger than a dimension of the plate-shaped member in a direction parallel to the coil axis. The area of the plate-shaped member is smaller than the area of the first end surface of the multilayer body.

The disclosure (2) is the laminated coil component according to the disclosure (1), in which when the cross-sectional area of the coil is assumed to be 1, the area of the plate-shaped member is 1.63 or less.

The disclosure (3) is the laminated coil component according to the disclosure (1) or (2), in which the plate-shaped member is located between the coil conductor closest to the first end surface and the first end surface in the longitudinal direction.

The disclosure (4) is the laminated coil component according to the disclosure (1) or (2), in which the plate-shaped member is located at a position at which the plate-shaped member is exposed on the first end surface of the multilayer body, and the first outer electrode covers at least part of the plate-shaped member.

The disclosure (5) is the laminated coil component according to the disclosure (1) or (2), in which the plate-shaped member is located inside the coil.

The disclosure (6) is a laminated coil component combined with any one of the disclosures (1) to (5), in which the plate-shaped member is composed of an inorganic material.

The disclosure (7) is a laminated coil component combined with any one of the disclosures (1) to (6), in which the plate-shaped member contains the same metal element as the coil.

The disclosure (8) is a laminated coil component combined with any one of the disclosures (1) to (6), in which the plate-shaped member is composed of a metal and electrically connected to the coil.

The disclosure (9) is a laminated coil component combined with any one of the disclosures (1) to (6), in which the plate-shaped member contains the same ceramic material as the insulation layers.

The disclosure (10) is a laminated coil component combined with any one of the disclosures (1) to (9), in which the multilayer body includes a plurality of the plate-shaped members.

The disclosure (11) is the laminated coil component according to the disclosure (10), in which at least one of the plate-shaped members is located between the coil conductor closest to the first end surface and the first end surface in the longitudinal direction, and at least one of the plate-shaped members is located between the coil conductor closest to the second end surface and the second end surface in the longitudinal direction.

The disclosure (12) is the laminated coil component according to the disclosure (10), in which when the multilayer body is assumed to be bisected in the longitudinal direction into a region on the first end surface side and a region on the second end surface side. Also, at least one of the plate-shaped members is located in each of the region on the first end surface side and the region on the second end surface side, and the number of plate-shaped members differs between the region on the first end surface side and the region on the second end surface side.

The disclosure (13) is a laminated coil component combined with any one of the disclosures (1) to (12), in which the difference between the depth of a depression in the first end surface of the multilayer body and the depth of a depression in the second end surface of the multilayer body is 12 μm or less.

The disclosure (14) is a laminated coil component combined with any one of the disclosures (1) to (13), in which when the cross-sectional area of the coil is assumed to be 1, the area of the plate-shaped member is within a range from 0.18 to 1.40 inclusive.

The disclosure (15) is a laminated coil component combined with any one of the disclosures (1) to (14), in which in transparent view of the multilayer body in the longitudinal direction, an outer peripheral shape of the plate-shaped member is similar to an inner peripheral shape of a circling-shape portion of the coil.

The disclosure (16) is a method of manufacturing a laminated coil component, including preparing ceramic green sheets containing a ceramic material; printing by applying a conductor paste serving as a coil conductor layer and/or a via conductor to the ceramic green sheets; producing an unsintered multilayer body including an unsintered coil by laminating the ceramic green sheets on which the coil conductor layer is formed; and producing a multilayer body by sintering the unsintered multilayer body. The producing an unsintered multilayer body or the printing further includes providing a layer containing an inorganic material and having a smaller area than the ceramic green sheets.

The disclosure (17) is the method of manufacturing a laminated coil component according to the disclosure (16), in which the providing a layer containing an inorganic material is printing by applying a paste containing an inorganic material to part of a surface of the ceramic green sheets.

The disclosure (18) is the method of manufacturing a laminated coil component according to the disclosure (17), in which the paste applied contains the same ceramic material as the ceramic green sheets.

The disclosure (19) is the method of manufacturing a laminated coil component according to the disclosure (17), in which the paste applied contains the same metal element as the conductor paste serving as the coil conductor layer.

The disclosure (20) is the method of manufacturing a laminated coil component according to the disclosure (16), in which the providing a layer containing an inorganic material is laminating a solid plate-shaped member together with the ceramic green sheets in the producing an unsintered multilayer body.

The disclosure (21) is the method of manufacturing a laminated coil component according to the disclosure (20), in which the solid plate-shaped member contains the same ceramic material as the ceramic green sheets.

The disclosure (22) is the method of manufacturing a laminated coil component according to the disclosure (20), in which the solid plate-shaped member contains the same metal element as the conductor paste serving as the coil conductor layer.

### Implementation Example

The following describes implementation examples in which the present disclosure is specifically disclosed. However, the present disclosure is not limited to only these implementation examples.

### Implementation Example 1 and Comparative Example 1

### Production of Laminated Coil Components

According to the foregoing method of manufacturing a laminated coil component, twenty multilayer bodies according to Implementation Example 1 including plate-shaped members and twenty multilayer bodies according to Comparative Example 1 without plate-shaped members were produced. The dimensions of all of the multilayer bodies were set to the size of 3225 (length×height×width=3.2 mm×2.5 mm×2.5 mm). In the multilayer bodies according to Implementation Example 1, six layers of via sheets are placed on both the first end surface side and the second end surface side as illustrated in FIG. 2, and two plate-shaped members are placed only on the first end surface side. The number of laminated coil sheets was set to 72. As for the circling-shape portions of the coil, the inner peripheral shape was set to a square each side of which is approximately 480 μm. The plate-shaped members were formed by printing a square region by applying the Ag paste the same as used for the internal electrodes to the regions of surfaces of via sheets, corresponding to the inner side of the circling-shape portions of the coil. In this process, the Ag paste serving as the plate-shaped members was placed such that the Ag paste is not in contact with the conductor paste serving as the via conductor, that the center of gravity of the Ag paste is at the position aligned with the center of gravity of the inner peripheral shape of the circling-shape portions of the coil, and that each side of the square is parallel to the inner peripheral shape of the circling-shape portions of the coil.

A laminated coil component according to Implementation Example 1 was ground from a side surface (LT surface) to the center of the W dimension to obtain a cross section. The cross section was observed with a digital microscope. The length from the most bulging portion in the first end surface in the longitudinal direction L of the multilayer body to the most depressed portion in the portion overlapping the inner side of the circling-shape portions of the coil was measured as the depth of the depression (the depth of the first depression). The result was 10.4 μm. The thickness of one plate-shaped member in the same cross section was 22.0 μm. The distance of two plate-shaped members was 28.0 μm. The distance from the first end surface of the multilayer body to the plate-shaped member in the longitudinal direction of the multilayer body was 60.4 μm. The distance from the outermost coil layer to the plate-shaped member in the longitudinal direction of the multilayer body was 22.3 μm. In addition, the dimension of the plate-shaped member in the height direction was checked in the cross section and found to be 435 μm. Thus, it was found that the outer peripheral shape of the plate-shaped member was a square one side of which was 435 μm and the area of which was 189225 μm². Similarly, the height of the inner peripheral shape of the circling-shape portion of the coil was checked in the cross section and found to be 526 μm. Thus, it was found that the inner peripheral shape of the circling-shape portion of the coil was a square one side of which was 526 μm and the area of which (the cross-sectional area of the coil) was 276676 μm².

The multilayer body according to Comparative Example 1 was set to be the same as or similar to the one according to Implementation Example 1 except that plate-shaped members are not included. The depth of the depression of a laminated coil component according to Comparative Example 1 was also measured by a method the same as or similar to the one in Implementation Example 1 and found to be 45 μm.

From the above results, it was confirmed that the plate-shaped members enable the size of the coil marks in the multilayer body to be reduced.

### Implementation Examples 2 to 6

Laminated coil components were produced by the procedures the same as or similar to those in Implementation Example 1 except that the size (the length of one side of the square) of the Ag paste applied to via sheets was changed so that the length of each side of the outer peripheral shape of the plate-shaped member was changed to 115 μm, 285 μm, 520 μm, 605 μm, and 229 μm, and the depth (the size) of the depression was measured. The results are shown in Table 1.

TABLE 1

| | Length of | | Length of | | Ratio | |
|---|---|---|---|---|---|---|
| | One Side | | One Side | | of Area | |
| | of Outer | | of Inner | | of Plate- | |
| | Peripheral | | Peripheral | | Shaped | |
| | Shape of | Area of | Shape of | Cross- | Member to | |
| | Plate- | Plate- | Circling- | Sectional | Cross- | |
| | Shaped | Shaped | Shape | Area of | Sectional | Depth of |
| | Member | Member | Portion of | Coil | Area of | Depression |
| | [μm] | [μm²] | Coil [μm] | [μm²] | Coil | [μm] |
| Implementation | 435 | 189225 | 526 | 276676 | 0.68 | 10.4 |
| Example 1 | | | | | | |
| Implementation | 115 | 13225 | 526 | 276676 | 0.05 | 36.4 |
| Example 2 | | | | | | |
| Implementation | 285 | 81225 | 526 | 276676 | 0.29 | 16.0 |
| Example 3 | | | | | | |
| Implementation | 520 | 270400 | 526 | 276676 | 0.98 | 13.9 |
| Example 4 | | | | | | |
| Implementation | 605 | 366025 | 526 | 276676 | 1.32 | 11.8 |
| Example 5 | | | | | | |
| Implementation | 229 | 52441 | 526 | 276676 | 0.19 | 9.7 |
| Example 6 | | | | | | |
| Comparative | 0 | 0 | 526 | 276676 | 0 | 45 |
| Example 1 | | | | | | |

As shown in Table 1, it was confirmed that the depth (the size) of the coil mark can be controlled by changing the area of the plate-shaped member. The above results show that the laminated coil component of the present disclosure enables the size of the coil mark of the multilayer body end surfaces to be reduced and thus enables the structural defects of the outer electrodes to be reduced.

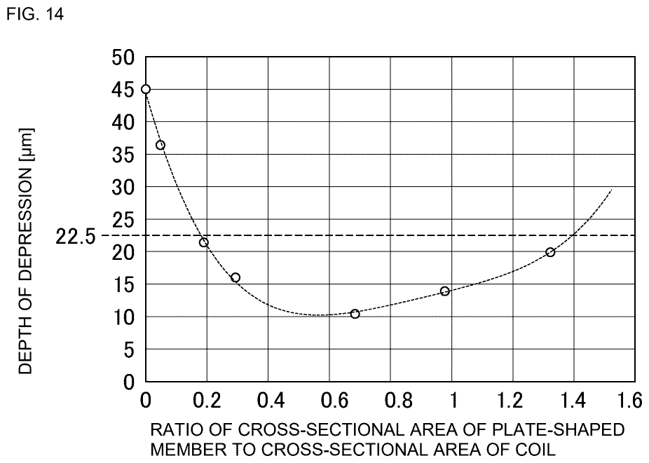

FIG. 14 shows a graph obtained by plotting the relationship between the ratio of the area of the plate-shaped member to the cross-sectional area of the coil and the depth of the depression for each of the laminated coil components according to Implementation Examples 1 to 6, and an approximation curved line added to the graph. From the approximation curved line (R²=0.9985) shown in FIG. 14, it was found that to make the depth of the depression (the size of the coil mark) smaller than or equal to 22.5 μm, the ratio of the area of the plate-shaped member to the cross-sectional area of the coil needs to be 0.18 or more and 1.40 or less (i.e., from 0.18 to 1.40). Note that it is considered that in the case in which a conductive paste serving as outer electrodes is applied to the end surfaces of the multilayer body by a dip method, and the depth of the coil mark is 22.5 μm or less, defects in forming outer electrodes are less likely to occur. Hence, it can be said that particularly the laminated coil components according to Implementation Examples 1 and 3 to 6 are suitable for the laminated coil components manufactured by dip methods.

What is claimed is:

1. A laminated coil component comprising:
a multilayer body including a plurality of laminated insulation layers and a coil inside; and
first and second outer electrodes electrically connected to the coil, wherein
the coil includes a plurality of coil conductors which are laminated together with the insulation layers and are electrically connected to one another,
the multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction,
a coil axis of the coil is parallel to the first main surface,
the multilayer body further includes a plate-shaped member laminated together with the insulation layers, a dimension of the plate-shaped member in a direction perpendicular to the coil axis being larger than a dimension of the plate-shaped member in a direction parallel to the coil axis, and
an area of the plate-shaped member is smaller than an area of the first end surface of the multilayer body.

2. The laminated coil component according to claim 1, wherein
when a cross-sectional area of the coil is assumed to be 1, the area of the plate-shaped member is 1.63 or less.

3. The laminated coil component according to claim 1, wherein
the plate-shaped member is between the coil conductor closest to the first end surface and the first end surface in the longitudinal direction.

4. The laminated coil component according to claim 1, wherein
the plate-shaped member is at a position at which the plate-shaped member is exposed on the first end surface of the multilayer body, and
the first outer electrode covers at least part of the plate-shaped member.

5. The laminated coil component according to claim 1, wherein
the plate-shaped member is inside the coil.

6. The laminated coil component according to claim 1, wherein
the plate-shaped member includes an inorganic material.

7. The laminated coil component according to claim 1, wherein
the plate-shaped member includes the same metal element as the coil.

8. The laminated coil component according to claim 1, wherein
the plate-shaped member includes a metal and electrically connected to the coil.

9. The laminated coil component according to claim 1, wherein
the plate-shaped member includes the same ceramic material as the insulation layers.

10. The laminated coil component according to claim 1, wherein
the multilayer body includes a plurality of the plate-shaped members.

11. The laminated coil component according to claim 10, wherein
at least one of the plate-shaped members is between the coil conductor closest to the first end surface and the first end surface in the longitudinal direction, and
at least one of the plate-shaped members is between the coil conductor closest to the second end surface and the second end surface in the longitudinal direction.

12. The laminated coil component according to claim 10, wherein
when the multilayer body is assumed to be bisected in the longitudinal direction into a region on a first end surface side and a region on a second end surface side,
at least one of the plate-shaped members is in each of the region on the first end surface side and the region on the second end surface side, and
a number of plate-shaped members differs between the region on the first end surface side and the region on the second end surface side.

13. The laminated coil component according to claim 1, wherein
a difference between a depth of a depression in the first end surface of the multilayer body and a depth of a depression in the second end surface of the multilayer body is 12 μm or less.

14. The laminated coil component according to claim 1, wherein
when a cross-sectional area of the coil is assumed to be 1, the area of the plate-shaped member is within a range of from 0.18 to 1.40.

15. The laminated coil component according to claim 1, wherein
in transparent view of the multilayer body in the longitudinal direction,
an outer peripheral shape of the plate-shaped member is similar to an inner peripheral shape of a circling-shape portion of the coil.

16. A method of manufacturing a laminated coil component, comprising:
preparing ceramic green sheets including a ceramic material;
printing by applying a conductor paste serving as a coil conductor layer and/or a via conductor to the ceramic green sheets;
producing an unsintered multilayer body including an unsintered coil by laminating the ceramic green sheets on which the coil conductor layer is formed; and
producing a multilayer body by sintering the unsintered multilayer body, wherein
the producing an unsintered multilayer body or the printing further includes providing a layer including an inorganic material and having a smaller area than the ceramic green sheets.

17. The method of manufacturing a laminated coil component according to claim 16, wherein
the providing a layer including an inorganic material is printing by applying a paste including an inorganic material to a portion of a surface of the ceramic green sheets.

18. The method of manufacturing a laminated coil component according to claim 17, wherein
the paste applied includes the same ceramic material as the ceramic green sheets.

19. The method of manufacturing a laminated coil component according to claim 17, wherein
the paste applied includes the same metal element as the conductor paste serving as the coil conductor layer.

20. The method of manufacturing a laminated coil component according to claim 16, wherein
the providing a layer includes an inorganic material is laminating a solid plate-shaped member together with the ceramic green sheets in the producing an unsintered multilayer body.

21. The method of manufacturing a laminated coil component according to claim 20, wherein
the solid plate-shaped member includes the same ceramic material as the ceramic green sheets.

22. The method of manufacturing a laminated coil component according to claim 20, wherein
the solid plate-shaped member includes the same metal element as the conductor paste serving as the coil conductor layer.
